(19) United States
(12) Patent Application Publication
(10) Pub. No.: US 2022/0388167 A1
(43) Pub. Date: Dec. 8, 2022

(54) METHOD, COMPUTER PROGRAM PRODUCT AND ROBOT CONTROLLER FOR CONFIGURING A ROBOT-OBJECT SYSTEM ENVIRONMENT, AND ROBOT

(71) Applicant: Siemens Aktiengesellschaft, München (DE)

(72) Inventors: Frederik Deroo, Hallbergmoos (DE); Vincent Dietrich, München (DE); Robert Eidenberger, München (DE); Daniel Meyer-Delius Di Vasto, München (DE); Philipp Sebastian Schmitt, München (DE); Florian Wirnshofer, München (DE)

(21) Appl. No.: 17/781,119

(22) PCT Filed: Dec. 11, 2020
(86) PCT No.: PCT/EP2020/085852

§ 371 Date: May 31, 2022

(30) Foreign Application Priority Data
Dec. 11, 2019 (EP) 19215346.8

(51) Int. Cl. B25J 9/16; B25J 13/08

(52) U.S. Cl. CPC B25J 9/1653; B25J 9/1697; B25J 9/1671; B25J 13/089

(57) ABSTRACT

In order to be able to automatically eliminate discrepancies, arising in the course of the configuration of a robot-object system environment, between the reality of the robot-object system environment and its digital representation as a CAD model, without manual on-site commissioning of the robot-object system environment with adaptation of the CAD model to the reality, the following is proposed for configuring a robot-object system environment having at least one object and having a robot for object manipulation and object sensing: synchronizing a digital robot twin, which digitally represents the robot-object system environment and controls the robot for the object manipulation on the basis of a control program, for expedient use of the robot in the robot-object system environment during the object manipulation, appropriately and, in this regard, in one or two stages.

### CROSS-REFERENCE TO RELATED APPLICATIONS

This application claims priority to PCT Application No. PCT/EP2020/085852, having a filing date of Dec. 11, 2020, which claims priority to EP Application No. 19215346.8, having a filing date of Dec. 11, 2019, the entire contents both of which are hereby incorporated by reference.

### FIELD OF TECHNOLOGY

The following relates to a method for configuring a robot-object system environment, to a computer program product for configuring a robot-object system environment, to a robot controller for configuring a robot-object system environment, and to a robot.

### BACKGROUND

A robot-object system environment in the sense of the present invention is the environment of an automated system in which a robot is used as an automatically controlled, reprogrammable handling device of versatile use (for example in industry, in service, in the field or acting autonomously) and having a plurality of degrees of freedom, the movements of which are programmable and possibly sensor-guided, and which is either stationary or movable for the purpose of performing handling and/or manufacturing tasks on one or more objects or items. In this case, the automated system may be, for example in terms of form and shape, a manufacturing or robot cell.

For this use, it is necessary to configure the robot-object system environment or the cell in such a manner that discrepancies which arise between the reality of the robot-object system environment and its digital representation as a CAD model with respect to poses of the object and robot do not arise. In this case, the pose results from the combination of the position and orientation of a free rigid body (for example robot with its individual components and object) having 6 degrees of freedom in space. This is also referred to as a 6-D pose of the body. In general linguistic use, if the spatial position of a body needs to be determined and where exactly the pose of the body should actually be determined, reference is imprecisely made to the determination of a body position. Following this general linguistic use, the term “an object position” is also used within the scope of the present application and in the wake of this reference is also made to object position data even though the more precise use of the terms “object pose” and “object pose data” would actually be declared despite their rare occurrence in general linguistic use.

In a first phase, the digital robot twin DRZ′ is generated, for example by an engineer. For this purpose, the engineer uses a programming tool PGT, for example a “Totally Integrated Automation <TIA>” portal, to create the design of a control program STP′ and uses a “Computer Aided Design <CAD>” program CADP to create a hardware design of the robot-object system environment ROSU′. The control program STP′ which includes control logic for a robot and movement commands for the robot becomes a direct, integral part of the digital robot twin DRZ′, whereas the hardware design which includes geometrical data relating to the robot-object system environment ROSU′ is stored in a data memory DSP′ of the digital robot twin DRZ′. This is a current state AZ′ of the digital robot twin DRZ′.

In a second phase, the robot-object system environment ROSU′ or the robot cell is constructed, for example by a worker. This construction comprises the real local positioning of at least one object and of the robot in the robot-object system environment ROSU′ and the design of the robot-object system environment ROSU′ according to the geometrical data stored in the data memory DSP. The robot-object system environment ROSU′ actually constructed in this manner must now be synchronized with the digital robot twin DRZ′ in the current state AZ′.

In a third phase, the digital robot twin SYDRZ′ is consequently manually synchronized in the current state AZ′, for example by a start-up engineer of the robot-object system environment ROSU′. Although the result of this manually performed synchronization is an updated, synchronized state ASZ′ of the digital robot twin DRZ′, it is not necessarily ensured, as a result of the manual causation of the updated, synchronized state AZ′ of the digital robot twin DRZ′, that the discrepancies which have been identified and need to be avoided are also subsequently taken into account in the digital robot twin DRZ′.

This applies, in particular, in the case of subsequent changes to the product which require adaptation of the control program. If the digital robot twin DRZ′ has not been synchronized, the control program must be adapted to the installation in a complicated manner.

The start-up of the robot-object system environment is a crucial task in the field of automation and robotics and, if the time needed for such a start-up can therefore be shortened and automated, this results in a competitive advantage.

### SUMMARY

An aspect relates to a method, a computer program product (non-transitory computer readable storage medium having instructions, which when executed by a processor, perform actions) and a robot controller for configuring a robot-object system environment as well as a robot, in which discrepancies between the reality of the robot-object system environment and its digital representation as a CAD model which arise when configuring the robot-object system environment are eliminated automatically, without manual in-situ start-up of the robot-object system environment by adapting the CAD model to the reality.

Proceeding from the method defined in the preamble of method claim, this advantage is achieved by the method features specified.

In addition, proceeding from the computer program product claim defined.

Moreover, proceeding from the robot controller defined in the preamble of patent claim an advantage is achieved by the robot features specified.

Furthermore, proceeding from the robot defined, the advantage is achieved by the robot features.

The idea on which the invention is based according to the technical teaching respectively stated in the method, computer program product, robot controller and robot claims involves, for configuring a robot-object system environment having at least one object and a robot for manipulating and capturing objects, synchronizing a digital robot twin, which digitally represents the robot-object system environment and controls the robot for manipulating objects on the basis of a control program, for expedient use of the robot in the robot-object system environment when manipulating objects, as required—in the sense of a first-stage accuracy requirement or a first-stage accuracy requirement and a second-stage accuracy requirement—and in this respect, in one or two stages.

In this case, in a first stage, each object in the robot-object system environment is optically captured with respect to an object position during the control program run until

(i) the position of the object has been determined with sufficient accuracy for a first-stage accuracy requirement,

(ii) an improvement in the accuracy of the object position in the digital robot twin is required in a second stage with regard to the synchronization and is expedient under given conditions of the second-stage synchronization, or

(iii) it is not possible to improve the accuracy of the object position in the digital robot twin.

In the subsequent second stage, each object in the robot-object system environment is captured with respect to an object position during the control program run by determining an object pose distribution or by determining an object pose distribution and robot contact until

(i) the position of the object has been determined with sufficient accuracy for a second-stage accuracy requirement, or

(ii) it is not possible to improve the accuracy of the object position in the digital robot twin.

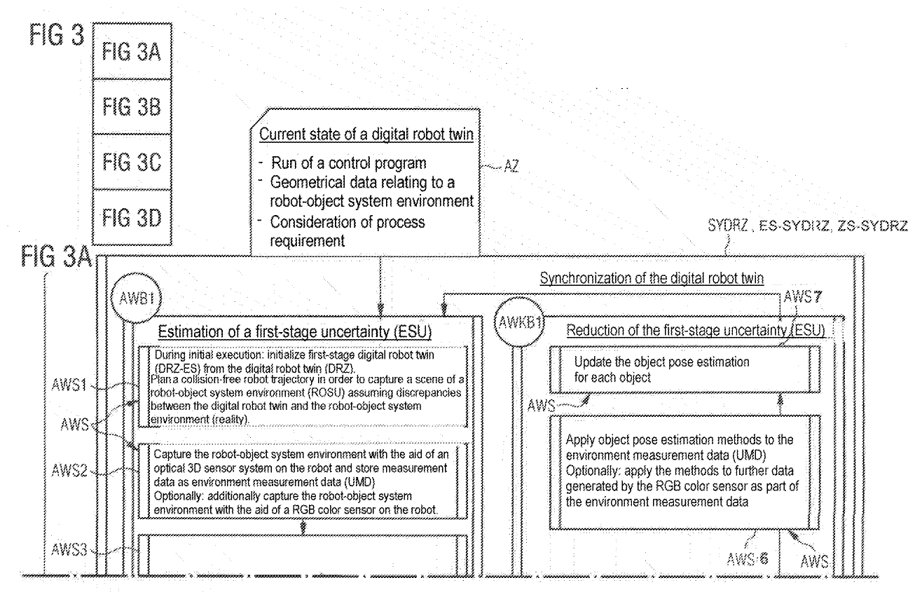

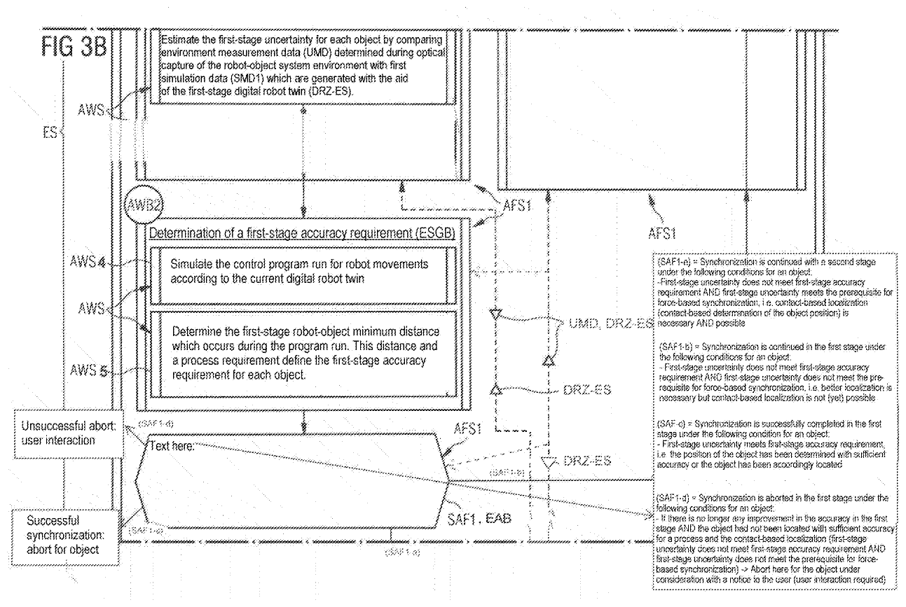

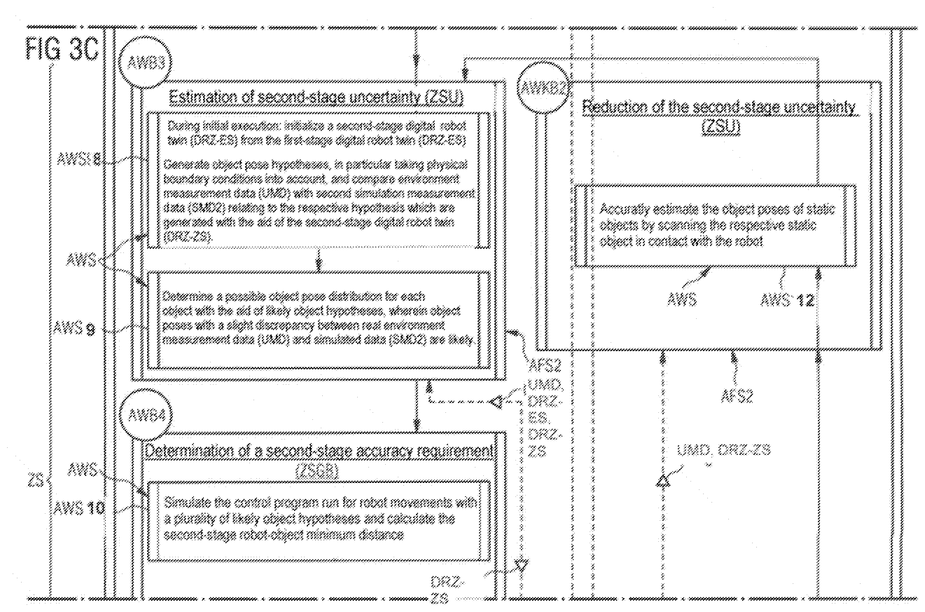

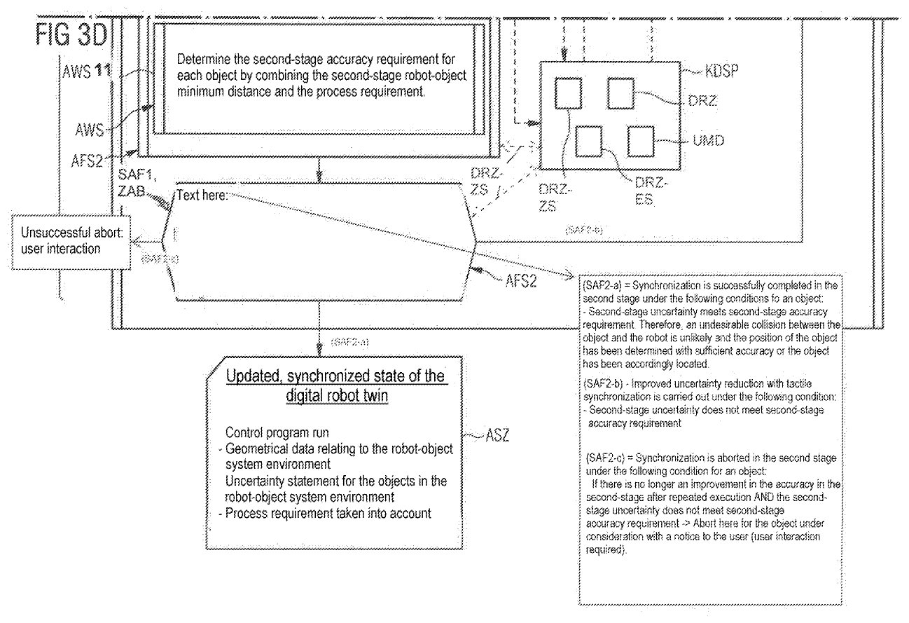

In the context of the synchronization of the digital robot twin that is carried out in two stages, it proves to be particularly advantageous if the synchronization is run through, as claimed in claims 2 to 9 and 13, in two polling loops (cf. FIG. 3), a first polling loop for each object in the first stage and a second polling loop for each object in the second stage.

The advantages lie in the fact that the synchronization of the digital robot twin as required is carried out either in one stage or in two stages depending on requirements. This reduces the runtime for the synchronization. Furthermore, for both stages, the control program is simulated with in each case a current digital robot twin, a first-stage digital robot twin and a second-stage digital robot twin. This makes it possible to automatically determine the respective accuracy requirement, the first-stage accuracy requirement and the second-stage accuracy requirement, on the basis of the current robot-object system environment and current discrepancies.

It can be considered to be particularly advantageous that the assessment of the current synchronization is ensured by a comparison step of simulated data and real data and a sampling step in which the possible distribution of object positions is estimated. In this case, a meaningful assessment is carried out by simulating the actual robot control program for various samples, which provides a measure of a failure probability of parts of the control program with respect to subprocess tasks.

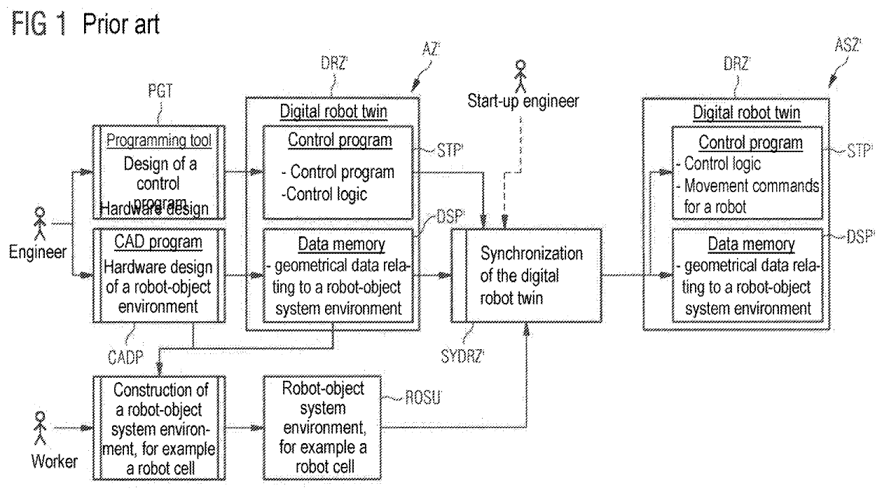

This makes it possible to increase the synchronization quality in comparison with the manual synchronization according to the conventional art (cf. FIG. 1). This is shown by the fact that errors and collisions when manipulating objects are avoided when the robot is used operationally in the robot-object system environment.

In addition, the start-up costs can be reduced in comparison with the manual start-up as a result of such automatically performed synchronization of the digital robot twin. This ultimately results in the robot-object system environment being able to be changed more frequently than before for various robot-assisted handling and/or manufacturing tasks.

Furthermore, the automatically performed synchronization of the digital robot twin ensures that the discrepancies which have been identified between the reality of the robot-object system environment and its digital representation and need to be avoided are also taken into account in the digital robot twin by appropriate automatic feedback.

### BRIEF DESCRIPTION

Some of the embodiments will be described in detail, with reference to the following figures, wherein like designations denote like members, wherein:

FIG. 1 shows a configuration of a robot-object system environment;

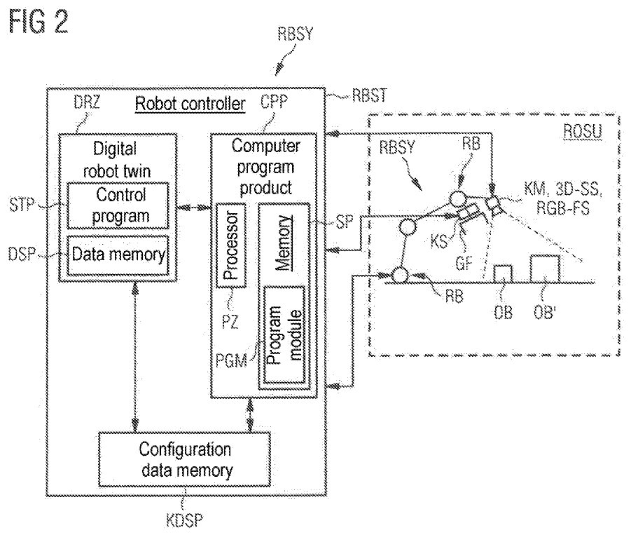

FIG. 2 shows an arrangement of a robot system and a robot-object system environment; and

FIG. 3 shows a flowchart for automatic digital robot twin synchronization

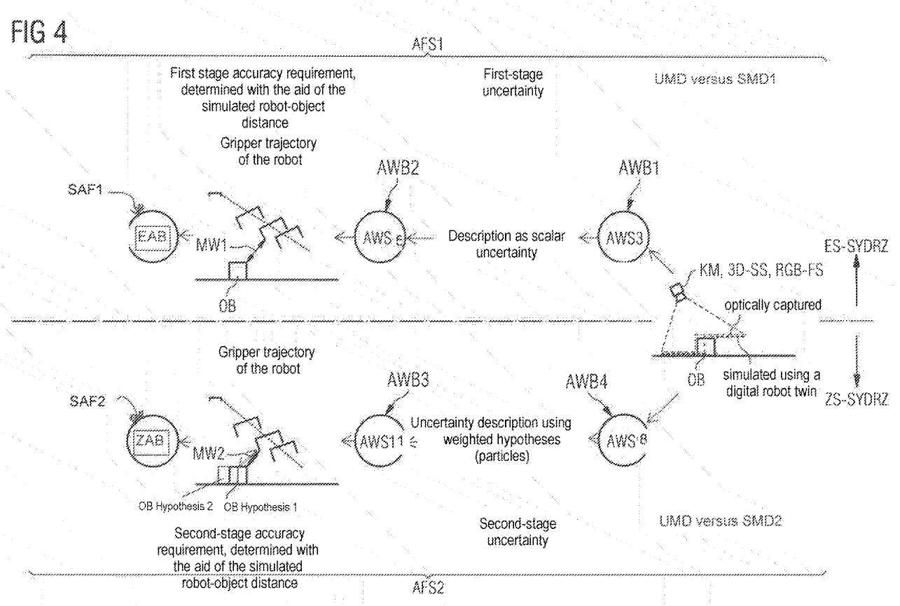

FIG. 4 shows an illustrative diagram for dedicated instruction steps and loop polls in the flowchart according to FIG. 3.

### DETAILED DESCRIPTION

FIG. 1 shows, on the basis of a basic schematic diagram, how the conventional configuration of a robot-object system environment ROSU′, which is in the form of a robot cell for example, takes place or is carried out in order to avoid the discrepancies which arise between the reality of the robot-object system environment ROSU′ and its digital representation by a digital robot twin DRZ′ which is also referred to in the technical jargon as a “digital twin”. This configuration is subdivided into three phases which are carried out independently of one another by manual measures by persons.

FIG. 2 shows an arrangement of a robot system RBSY and a robot-object system environment ROSU.

The robot system RBSY contains a robot RB, which is part of the robot-object system environment ROSU and is used there to manipulate and capture objects, and a robot controller RBST for controlling the robot RB in the robot-object system environment ROSU.

For this purpose, the robot controller RBST contains a digital robot twin DRZ, which digitally represents the robot-object system environment ROSU and controls the robot RB for manipulating objects, a computer program product CPP and a configuration data memory KDSP which functionally interact and/or are connected to one another in the illustrated manner for the purpose of forming a functional unit for configuring the robot-object system environment ROSU, also referred to as the robot-object system environment configuration below, and, in this context, for the purpose of controlling the robot RB.

The robot controller RBST may be, for example, either—like the robot RB—part of the robot system RBSY as an independent unit which is sold separately on the market, in which case the robot controller RBST and the robot RB may, but need not, be from the same manufacturer, or the robot controller RBST forms a structural unit with the robot RB in such a manner that it is matched to the robot RB and is sold as a bundle package with the latter.

The digital robot twin DRZ, like the digital robot twin DRZ′ in FIG. 1, is generated by an engineer again, for example, wherein, in this case too, a control program STP with control logic and movement commands for the robot RB, on the basis of which the robot RB in the robot-object system environment ROSU is controlled when manipulating objects, and a data memory DSP for storing geometrical data relating to the robot-object system environment ROSU are again contained in the digital robot twin DRZ.

Furthermore, a process requirement which defines accuracy requirements imposed on parts of the control program may be stored in the digital robot twin DRZ. For example, for a robot movement in which two objects are joined together, it is possible to define an accuracy requirement for the objects of 0.5 mm. This is expressed as a negative value and means that a penetration depth between the objects to be joined of a maximum of 0.5 mm should be determined during simulation. A positive value describes a minimum distance, that is to say no object contact is allowed in this case.

Data generated and provided in the context of the robot-object system environment configuration are stored in the configuration data memory KDSP. Which data these are is explained further below in connection with the description of FIG. 3.

The computer program product CPP, as a further part of the robot controller RBST, contains a non-volatile, readable memory SP, which stores processor-readable control program instructions of a program module PGM carrying out the robot-object system environment configuration, and a processor PZ which is connected to the memory SP and executes the control program instructions of the program module PGM for the robot-object system environment configuration.

To configure the robot-object system environment, the digital robot twin DRZ, which digitally represents the robot-object system environment ROSU and controls the robot RB for manipulating objects on the basis of the control program STP, is synchronized for expedient use of the robot RB in the robot-object system environment ROSU when manipulating objects. The manner in which this synchronization takes place in detail is also explained in connection with the description of FIG. 3.

By analogy with the above robot/robot controller consideration, in a robot controller/“computer program product” consideration, the computer program product CPP or, more precisely, the program module PGM, which carries out the robot-object system environment configuration and is respectively configured, provided or designed as an APP or as part of a programming environment or API for the robot controller, may now likewise be sold on the market separately and independently of the robot controller as a separate product from a manufacturer A and may then be used in any desired robot controller from a manufacturer B.

The robot-object system environment ROSU contains two objects, a first object OB and a second object OB′, which are to be manipulated and captured by the robot RB. For this purpose and for the robot-object system environment configuration, the robot RB has a gripper GF and a force sensor KS as an end effector and a camera KM and/or a 3-D sensor system 3D-SS in the region of the end effector.

In this case, the force sensor need not necessarily be represented as an independent unit, but rather can also be emulated using other sensor systems present in the robot.

It is optionally also possible for a “red/green/blue <RGB>” color sensor RGB-FS to also be fitted in the region of the end effector for the robot-object system environment configuration.

The manner in which these end effector components are used for the robot-object system environment configuration is likewise explained in connection with the description of FIG. 3.

FIG. 3 shows a flowchart for carrying out—in contrast to the manually performed digital robot twin synchronization SYDRZ′ according to FIG. 1—automatic digital robot twin synchronization SYDRZ in which the digital robot twin is synchronized as required—in the sense of a first-stage accuracy requirement or a first-stage accuracy requirement and a second-stage accuracy requirement—and in this respect in one or two stages. This flowchart is executed by the processor PZ in the computer program product during execution of the control program instructions of the program module PGM for configuring the robot-object system environment.

The starting point for carrying out the automatic digital robot twin synchronization SYDRZ is a current state AZ of the digital robot twin DRZ with the run of the control program STP contained in the digital robot twin DRZ and the geometrical data relating to the robot-object system environment ROSU which are stored in the data memory DSP.

The automatic digital robot twin synchronization SYDRZ now begins with optically capturing each object OB, OB′ in the robot-object system environment ROSU with respect to an object position during the run of the control program STP, according to a first stage ES with first-stage digital robot twin synchronization ES-SYDRZ, until

1. the position of the object OB, OB′ has been determined with sufficient accuracy for a first-stage accuracy requirement ESGB,

2. an improvement in the accuracy of the object position in the digital robot twin DRZ is required in a second stage ZS with regard to the synchronization and is expedient under given conditions of the second-stage synchronization, or

3. it is not possible to improve the accuracy of the object position in the digital robot twin DRZ.

After this, in a second stage ZS with second-stage digital robot twin synchronization ZS-SYDRZ, each object OB, OB′ in the robot-object system environment ROSU is captured with respect to an object position during the run of control program STP by determining an object pose distribution or by determining an object pose distribution and robot contact until

1. the position of the object OB, OB′ has been determined with sufficient accuracy for a second-stage accuracy requirement ZSGB, or

2. it is not possible to improve the accuracy of the object position in the digital robot twin DRZ.

The first-stage accuracy requirement ESGB is fundamentally determined by the process and therefore results from simulation. For certain parts of the control program, the first-stage accuracy requirement ESGB may also be overwritten by the process requirement.

The accuracy requirement results from a robot-object minimum distance, that is to say, if the robot RB is at a minimum distance of 10 cm from an object, determination of the object position, also called localization of the object, up to 10 cm precisely suffices.

The first-stage accuracy requirement ESGB is therefore scalar, that is to say it is described by a single value, for example 10 cm.

However, for some objects, there is contact during the control program run, thus resulting in a minimum distance value of a first-stage robot-object minimum distance of less than or equal to “0 cm”. In this case, negative values describe the maximum penetration depth.

The first-stage robot-object minimum distance is the shortest simulated robot-object distance across all time steps over the simulated control program and requires the control program to be simulated with the current estimation of the environment.

The simulated robot-object distance is the shortest distance between the surfaces of the robot, together with the gripper and workpiece (=end-of-arm tooling) and an object for a time in the control program run.

The shortest distance is determined with the aid of the outer envelope of the robot (together with attachments, end effector and temporarily attached objects) and of the target object in the form of a 3-D surface representation.

In addition, the first-stage accuracy requirement ESGB may be extended by a process requirement. In this case, for parts of the control program, the process requirement overwrites the existing value of the first-stage accuracy requirement ESGB for that part of the control program which is under consideration.

Upon contact, that is to say the minimum distance value of the first-stage robot-object minimum distance is less than or equal to 0 cm, a picking-up, setting-down and/or joining process generally takes place. Here, the requirement is overwritten by heuristic values stored in the digital robot twin and/or by user inputs for the process.

For example, the joining process requires a positioning accuracy of 0.5 mm. This is formulated as a negative value and means that a penetration depth between the objects to be joined of at most 0.5 mm should be determined during simulation.

The second-stage accuracy requirement ZSGB is comparable to the first-stage accuracy requirement ESGB, but with the difference that a second-stage robot-object minimum distance is used:
second-stage robot-object minimum distance if no process requirement is formulated OR
process requirement, if present.

In the case of robot-object minimum distance estimations of less than or equal to ZERO and with no indication of process requirement values, a request from the process requirement to an operator for configuration follows.

The estimation of the robot-object minimum distance in the second stage is determined as far as possible in the same way as the estimation of the first-stage robot-object minimum distance. The difference lies in the fact that the robot-object minimum distance is repeatedly determined for various hypotheses. Sampled particles from probabilistic pose distributions are typically referred to as hypotheses. In this case, the control program is simulated repeatedly with highly weighted characteristic pose hypotheses, for example determined as a mean value of the components of a “Mixture of Gaussian Approximation”, as an object pose in the digital twin. However, the distance between the robot and all hypotheses is calculated. However, the distance estimation is still formulated in a scalar manner and only the calculation differs. The minimum distance denotes the shortest distance in the set of all determined distances. Particles with a weighting below a heuristic threshold are rejected in this case for the calculation of the second-stage robot-object minimum distance. This is an approximation which can be carried out because the start-up engineer will still observe the first performance of the process. However, it is ideally only monitored and not adapted in comparison with the “state of the art”.

Building on this basic principle of automatic first-stage digital robot twin synchronization ES-SYDRZ, a first polling loop AFS1 is now run through for each object OB, OB′ in the first stage ES and a second polling loop AFS2 is run through in the second stage ZS.

A first-stage uncertainty ESU is therefore estimated in the first polling loop AFS1 in a first instruction block AWB1 for each run by optically capturing environment measurement data UMD and comparing them with first simulation measurement data SMD1 which are generated with the aid of a first-stage digital robot twin DRZ-ES. For this purpose, the first-stage digital robot twin DRZ-ES is initialized with the data relating to the digital robot twin DRZ during initial execution. The determined environment measurement data UMD and the first-stage digital robot twin DRZ-ES are—like the digital robot twin DRZ—stored in the configuration data memory KDSP and read by the processor PZ.

The first-stage uncertainty ESU denotes the uncertainty estimation of a pose estimation in scalar form, for example 3 cm. The value is determined by comparing the simulated data, the first simulation measurement data SMD1, with real measurement data relating to the object, the environment measurement data UMD. Depending on the detection method, a distance measure may be used for depth data, for example, and heuristics or measurement models can be used for RGB-based detection methods to determine the uncertainty.

Furthermore, the first-stage accuracy requirement ESGB is determined in the first polling loop AFS1 in a second instruction block AWB2, which is run through after the first instruction block AWB1, for each run.

To conclude the first polling loop AFS1, loop run conditions are checked in a first loop poll SAF1. This checking of the loop run conditions is explained below.

A first loop run condition check SAF1-a is used to check whether (i) the first-stage uncertainty ESU meets the first-stage accuracy requirement ESGB and (ii) the prerequisite for force-based synchronization is met and, if (i) is not met and (ii) is met, the first-stage digital robot twin synchronization ES-SYDRZ is continued with force-based synchronization in the second stage ZS. The transition from the first-stage digital robot twin synchronization ES-SYDRZ to the second-stage digital robot twin synchronization ZS-SYDRZ therefore takes place. Since force-based synchronization cannot always be carried out reliably and quickly, the uncertainty in the object position must meet the prerequisite.

A second loop run condition check SAF1-b is used to check whether (i) the first-stage uncertainty ESU meets the first-stage accuracy requirement ESGB and (ii) the prerequisite for force-based synchronization is met and, if (i) and (ii) are not met, the first-stage uncertainty ESU is reduced with the aid of object pose estimation methods applied to the optical environment measurement data UMD in a first instruction correction block AWKB1.

A third loop run condition check SAF1-c is used to check whether the first-stage uncertainty ESU meets the first-stage accuracy requirement ESGB, and if this is met, the first-stage digital robot twin synchronization ES-SYDRZ can be successfully completed for the respective object OB, OB′ after running through the first stage ES, with the result that both the first-stage digital robot twin synchronization ES-SYDRZ and the synchronization of the digital robot twin SYDZ are therefore ended.

A fourth loop run condition check SAF1-d is used to check whether (i) there is an improvement in the first-stage uncertainty ESU in the first stage ES and (ii) the prerequisite for force-based synchronization is met in the second stage ZS and, if (i) no longer takes place and (ii) is not met, the synchronization of the first-stage digital robot twin ES-SYDZ is aborted and the synchronization of the digital robot twin SYDZ is interrupted for a user interaction.

At this point, the user is provided with a display, for example, of the reason why the interaction takes place and the user now has the following possibilities for action:
Abort the first stage ES for the object with or without safeguarding the partially updated first-stage digital robot twin DRZ-ES. This results in a continuation for the rest of the robot-object system environment ROSU.
Abort the synchronization of the digital robot twin SYDZ for the object with or without safeguarding the partially updated first-stage digital robot twin DRZ-ES.
Set the process requirement for subprocesses.
Continue the first stage ES.

Dedicated instruction steps AWS are carried out when running through the first instruction block AWB1.

In a first instruction step AWS1 for planning a robot trajectory, a scene of the robot-object system environment ROSU is captured assuming discrepancies between the reality and the first-stage digital robot twin DRZ-ES. For this purpose, in a second instruction step AWS2, the robot-object system environment ROSU is captured with the aid of a sensor system on the robot RB. This sensor system may be, for example according to the illustration in FIG. 2, the camera KM, the 3-D sensor system 3D-SS. However, it is optionally also possible for the RGB color sensor RGB-FS to additionally also be fitted to the robot RB to optically capture the robot-object system environment ROSU. In these cases which characterize the sensor system, the environment measurement data UMD are 3-D image data 3D-BD generated by the 3-D sensor system 3D-SS and/or sensor data SSD generated by the RGB color sensor RGB-FS.

In a further, third instruction step AWS3, the first-stage uncertainty ESU is now estimated for each object OB, OB′, as already mentioned, by comparing the environment measurement data UMD determined during the optical capture of the robot-object system environment with the first simulation measurement data SMD1 which are generated with the aid of the first-stage digital robot twin DRZ-ES.

When running through the second instruction block AWB2, further dedicated instruction steps AWS are again carried out, like when running through the first instruction block AWB1.

In a fourth instruction step AWS4, the run of the control program STP is simulated for movements of the robot RB in accordance with the first-stage digital robot twin DRZ-ES.

In a further, fifth instruction step AWS5, a first minimum distance value MDW1 of a first robot-object minimum distance that defines the first-stage accuracy requirement ESGB is determined for each object OB, OB′, which robot-object minimum distance occurs during the simulated control program run.

In this case, the first robot-object minimum distance is the shortest robot-object distance across all time steps of the simulated control program. This requires simulation of the control program using the current first-stage digital robot twin DRZ-ES. The shortest distance is determined with the aid of the outer envelope of the robot (together with attachments, end effector and temporarily attached objects) and of the target object in the form of a 3-D surface representation.

Finally, further dedicated instruction steps AWS are also additionally carried out in the course of the first polling loop AFS1 while running through the first instruction correction block AWKB1.

In a sixth instruction step AWS6, object pose estimation methods are applied to the environment measurement data UMD [as the reference for such object pose estimation methods, the European patent application (application no. 19178454.5) is cited, for example].

In a further, seventh instruction step AWS7, the object pose estimation is updated for each object OB, OB′ in the first-stage digital robot twin DRZ-ES.

The upper half of FIG. 4 illustrates the first-stage synchronization of the digital robot twin ES-SYDRZ for the first polling loop AFS1 with the third instruction step AWS3 in the first instruction block AWB1, the fifth instruction step AWS5 in the second instruction block AWB2 and the first loop poll SFA1.

In the second stage ZS of the automatic second-stage digital robot twin synchronization ZS-SYDRZ, the second-stage uncertainty ZSU is estimated in the second polling loop AFS2 in a third instruction block AWB3 for each run by comparing second simulation measurement data SMD2 with the environment measurement data UMD.

In the second stage ZS—unlike in the first stage ES—the uncertainty is not considered as a scalar, but rather as a distribution in the form of a list (or set) of individual weighted hypotheses, so-called particles. This is a representation which is common for the robot RB, in particular in the case of mobile navigation, for example. It is determined by generating and assessing new hypotheses, referred to as so-called “sampling”. To assess the hypotheses, simulated depth values (depth images) of the object are compared with real (measured) depth values. Optionally, the results of optical estimation methods can be hereby taken into account in the weighting.

For this purpose, an object pose distribution is determined and is stored in the second-stage digital robot twin DRZ-ZS. The second-stage digital robot twin DRZ-ZS is initialized, in the first execution, with the data relating to the first-stage digital robot twin DRZ-ES, and the second simulation measurement data SMD2 are generated with the aid of the second-stage digital robot twin DRZ-ZS.

This second-stage digital robot twin DRZ-ZS—like the first-stage digital robot twin DRZ-ES, the digital robot twin DRZ and the environment measurement data UMD—is likewise stored in the configuration data memory KDSP and read by the processor PZ.

Furthermore, the second-stage accuracy requirement ZSGB is determined in the second polling loop AFS2 in a fourth instruction block AWB4, which is run through after the third instruction block AWB3, for each run.

To conclude the second polling loop AFS2, loop run conditions are checked in a second loop poll AFS2. This checking of the loop run conditions is explained below.

A first loop run condition check SAF2-a is used to check whether the second-stage uncertainty ZSU meets the second-stage accuracy requirement ZSGB and, if this is met, the second-stage digital robot twin synchronization ZS-SYDRZ is ended and the synchronization of the digital robot twin SYDRZ has been successfully concluded for the object under consideration.

A second loop run condition check SAF2-b is used to check whether the second-stage uncertainty ZSU meets the second-stage accuracy requirement ZSGB and, if this is not met, the second-stage uncertainty ZSU is reduced by scanning the respective object OB, OB′ in contact with the robot in a second instruction correction block AWKB2.

A third loop run condition check SAF2-c is used to check whether (i) the second-stage uncertainty ZSU meets the second-stage accuracy requirement ZSGB and (ii) there can still be an improvement in the second-stage uncertainty ZSU and, if (i) has not yet been met and (ii) is denied, the synchronization of the second-stage digital robot twin ES-SYDZ is aborted and the synchronization of the digital robot twin SYDZ is interrupted for a user interaction.

During the user interaction, the reason why the interaction is taking place is displayed to the user and there are the following possibilities for action:
Abort the second stage ZS for the object with or without safeguarding the partially updated second-stage digital robot twin DRZ-ZS. This results in a continuation of the synchronization process for the remaining objects.
Abort the entire process with or without safeguarding the partially updated second-stage digital robot twin DRZ-ZS.
Adapt the process requirement for subprocesses and continue the current synchronization stage.

Further dedicated instruction steps AWS are again carried out when running through the third instruction block AWB3.

In an eighth instruction step AWS8, object pose hypotheses are generated (sampled), in particular taking physical boundary conditions into account, and—as already mentioned—the environment measurement data UMD determined when capturing the robot-object system environment are compared with the second simulation measurement data SMD2. The second simulation measurement data SMD2 are generated by simulating a plurality of object pose hypotheses as part of the second-stage uncertainty ZSU and as part of the second-stage digital robot twin DRZ-ZS.

For completion when running through the third instruction block AWB3, a possible object pose distribution is determined for each object OB, OB′ in a ninth instruction step AWS9 with the aid of likely object pose hypotheses, wherein object poses with a smaller discrepancy between the determined environment measurement data UMD and the second simulation measurement data SMD2 are likely.

When running through the fourth instruction block AWB4, further dedicated instruction steps AWS are again carried out, like when running through the third instruction block AWB3.

In a tenth instruction step AWS10, the run of the control program STP is simulated for movements of the robot RB with a plurality of likely object pose hypotheses as part of the second-stage uncertainty ZSU and as part of the second-stage digital robot twin DRZ-ZS.

In a further, eleventh instruction step AWS11, a second minimum distance value MDW2 of a second-stage robot-object minimum distance that defines the second-stage accuracy requirement ZSGB is determined for each object OB, OB′, which second-stage robot-object minimum distance occurs during the simulated control program run.

The second-stage robot-object minimum distance is determined as far as possible in exactly the same way as the first-stage robot-object minimum distance. The difference lies in the fact that the robot-object minimum distance is repeatedly determined for various object pose hypotheses. Sampled particles from probabilistic pose distributions are typically referred to as object pose hypotheses. In this case, the control program is simulated repeatedly with highly weighted characteristic pose hypotheses which are determined, for example, as components of a “Mixture of Gaussian Approximation”. However, the distance between the robot and all hypotheses is calculated. However, the distance estimation is still formulated in a scalar manner and only the calculation differs. The minimum distance denotes the shortest distance in the set of all determined distances. Hypotheses with a weighting below a threshold are rejected in this case for the calculation of the second-stage robot-object minimum distance.

The second-stage accuracy requirement ZSGB is comparable to the first-stage accuracy requirement ESGB, with the difference that the second-stage robot-object minimum distance is used:
second-stage robot-object minimum distance if no process requirement is formulated OR
process requirement, if present.

In the case of robot-object minimum distance estimations which are less than or equal to ZERO, which corresponds to a collision between the robot RB and the object OB, OB′, and with no indication of process requirement values, a request to the user to configure the process requirement follows.

During the second polling loop ASF2, a further dedicated instruction step AWS is additionally finally also carried out when running through the second instruction correction block AWKB2.

In a twelfth instruction step AWS12, object poses of static objects of the objects OB, OB′ are estimated by scanning the respective static object in contact with the robot.

The lower half of FIG. 4 illustrates the second-stage synchronization of the digital robot twin ZS-SYDRZ for the second polling loop AFS2 with the eighth instruction step AWS8 in the third instruction block AWB3, the eleventh instruction step AWS11 in the fourth instruction block AWB4 and the second loop poll SFA2.

The performance of the automatic digital robot twin synchronization SYDRZ ends with the digital robot twin DRZ, including the control program STP or the control program run controlling the robot RB for manipulating objects, the geometrical data relating to the robot-object system environment ROSU which are stored in the data memory DSP and/or uncertainty statements for the objects OB, OB′ in the robot-object system environment ROSU, being updated after the synchronization of the digital robot twin SYDRZ which has been carried out—as explained above—in an updated, synchronized state ASZ of the digital robot twin DRZ.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for configuring a robot-object system environment having at least one object and a robot for manipulating and capturing objects, in which a digital robot twin, which digitally represents the robot-object system environment and controls the robot for manipulating objects on the basis of a control program, is synchronized for expedient use of the robot in the robot-object system environment when manipulating objects, wherein
the digital robot twin is synchronized, as required and in this respect, in one or two stages, wherein
a) in a first stage, each object the robot-object system environment is optically captured with respect to an object position during the control program run until
a1) the position of the object has been determined with sufficient accuracy for a first-stage accuracy requirement,
a2) an improvement in the accuracy of the object position in the digital robot twin is required in a second stage with regard to the synchronization and is expedient under given conditions of the second-stage synchronization, or
a3) it is not possible to improve the accuracy of the object position in the digital robot twin,
b) in the second stage, each object in the robot-object system environment is captured with respect to an object position during the control program run by determining an object pose distribution or by determining an object pose distribution and robot contact until
b1) the position of the object has been determined with sufficient accuracy for a second-stage accuracy requirement, or
b2) it is not possible to improve the accuracy of the object position in the digital robot twin.

2. The method as claimed in claim 1, wherein
a first polling loop is run through for each object in the first stage, in which
a) a first-stage uncertainty is estimated in a first instruction block during each run by comparing environment measurement data determined when optically capturing objects with first simulation measurement data from a first-stage digital robot twin,
b) the first-stage accuracy requirement is determined in a second instruction block, which is run through after the first instruction block, during each run,
c) loop run conditions are checked in a first-stage loop poll, wherein
there is a change from the first stage to the second stage on account of a first loop run condition check,
the first polling loop is run through on account of a second loop run condition check,
the synchronization of the digital robot twin has been successfully carried out and is therefore ended on account of a third loop run condition check,
the synchronization of the digital robot twin cannot be successfully carried out on account of a fourth loop run condition check and is therefore aborted, and user actions are therefore required,
d) when running through the first polling loop in a first instruction correction block, object position data relating to the first-stage digital robot twin are updated by applying object pose estimation methods to the environment measurement data to thus reduce the first-stage uncertainty.

3. The method as claimed in claim 2, wherein
dedicated instruction steps are carried out when running through the first instruction block, for example
a first instruction step for planning a robot trajectory to capture a scene of the robot-object system environment assuming discrepancies between the digital robot twin and the robot-object system environment,
a second instruction step for capturing and storing the environment measurement data relating to the robot-object system environment with the aid of an optical system, for example a 3-D sensor system, or with the aid of an optical system, for example a 3-D sensor system, and a sensor, for example a RGB color sensor, on the robot,
a third instruction step for estimating the first-stage uncertainty for each object by comparing the environment measurement data determined when optically capturing the robot-object system environment with the first simulation measurement data.

4. The method as claimed in claim 2, wherein
further steps of the dedicated instruction steps are carried out when running through the second instruction block, for example
a fourth instruction step for simulating the run of the control program for movements of the robot in accordance with the digital robot
a fifth instruction step for determining a first minimum distance value of a first-stage robot-object minimum distance that defines the first-stage accuracy requirement for each object, which first-stage robot-object minimum distance occurs during the simulated control program run; in particular, if there is a process requirement for a subprocess, this is used as the first-stage accuracy requirement in the subprocess.

5. The method as claimed in claim 2, wherein
further steps of the dedicated instruction steps are additionally carried out when running through the first instruction correction block, for example
a sixth instruction step for applying object pose estimation methods to the captured environment measurement data,
a seventh instruction step for updating the object pose estimation for each object in the first-stage digital robot twin.

6. The method as claimed in claim 1, wherein
a second polling loop is run through for each object in the second stage, in which
a) a second-stage uncertainty estimated in a third instruction block during each run by comparing the environment measurement data which have already been captured with second simulation measurement data from a second-stage digital robot twin,
b) the second-stage accuracy requirement is determined in a fourth instruction block, which is run through after the third instruction block, during each run,
c) loop run conditions are checked in a second-stage loop poll such a manner that
the synchronization of the digital robot twin has been successfully carried out and is therefore completed on account of a first loop run condition check,
the second polling loop is run through with tactile synchronization on account of a second loop run condition check for the purpose of reducing the second-stage uncertainty,
the synchronization of the digital robot twin cannot be successfully carried out on account of a third loop run condition check and is therefore aborted, and user actions are therefore required,
d) the second-stage digital robot twin is changed when running through the second polling loop in a second instruction correction block for the purpose of reducing the second-stage uncertainty for the run by tactile scanning in the third instruction block.

7. The method as claimed in claim 6, wherein
dedicated instruction steps are carried out when running through the third instruction block, for example
an eighth instruction step for generating object pose hypotheses, in particular taking physical boundary conditions into account, and for comparing the environment measurement data determined when optically capturing the robot-object system environment with the second simulation measurement data,
a ninth instruction step for determining a possible object pose distribution for each object with the aid of likely object pose hypotheses, wherein object poses with a smaller discrepancy between the environment measurement data and the second simulation measurement data are likely.

8. The method as claimed in claim 6, wherein
further steps of the dedicated instruction steps are carried out when running through the fourth instruction block, for example
a tenth instruction step OW for simulating the run of the control program for movements of the robot with a plurality of likely object pose hypotheses of the second-stage digital robot twin,
an eleventh instruction step for determining a second minimum distance value of a second-stage robot-object minimum distance that defines the second-stage accuracy requirement for each object, which second-stage robot-object minimum distance occurs during the simulated control program run; in particular, if there is a process requirement for a subprocess, this is used as the first-stage accuracy requirement in the subprocess.

9. The method as claimed in claim 6, wherein a further step of the dedicated instruction steps is additionally carried out when running through the second instruction correction block, for example
a twelfth instruction step for accurately estimating the object poses of static objects of the objects by scanning the respective static object in contact with the robot.

10. The method as claimed in claim 2, wherein the environment measurement data contain at least one of 3-D image data and sensor data.

11. The method as claimed in claim 1, wherein after synchronization, the digital robot twin, including the control program controlling the robot for manipulating objects, geometrical data relating to the robot-object system environment, a process requirement and/or uncertainty statements for the objects in the robot-object system environment, is updated.

12. A computer program product Comprising a computer readable hardware storage device having computer readable program code stored therein said program code executable by a processor of a computer system to implement a method for configuring a robot-object system environment which has at least one object and a robot for manipulating and capturing objects, having a non-volatile, readable memory which stores processor-readable control program instructions of a program module carrying out the robot-object system environment configuration, and a processor which is connected to the memory, executes the control program instructions of the program module for configuring the robot-object system environment and in the process synchronizes a digital robot twin, which digitally represents the robot-object system environment and controls the robot for manipulating objects on the basis of a control program, for expedient use of the robot in the robot-object system environment, when manipulating objects,
wherein
the program module is created and the processor executing the control program instructions of the program module for configuring the robot-object system environment is configured in such a manner that the digital robot twin is synchronized, as required and in this respect, in one or two stages, wherein
a) in a first stage, each object in the robot-object system environment is optically captured with respect to an object position during the control program run until
a1) the position of the object has been determined with sufficient accuracy for a first-stage accuracy requirement,
a2) an improvement in the accuracy of the object position in the digital robot twin is required in a second stage with regard to the synchronization and is expedient under given conditions of the second-stage synchronization, or
a3) it is not possible to improve the accuracy of the object position in the digital robot twin,
b) in the second stage, each object in the robot-object system environment is captured with respect to an object position during the control program run by determining an object pose distribution or by determining an object pose distribution and robot contact until
b1) the position of the object has been determined with sufficient accuracy for a second-stage accuracy requirement, or
b2) it is not possible to improve the accuracy of the object position in the digital robot twin.

13. The computer program product as claimed in claim 12, wherein the program module is created and the processor executing the control program instructions of the program module for configuring the robot-object system environment is configured in such a manner that the method steps of the method are carried out.

14. A robot controller for configuring a robot-object system environment which has at least one object and a robot for manipulating and capturing objects, having a digital robot twin which contains a control program, which controls the robot in the robot-object system environment when manipulating objects, and a data memory, which contains geometrical data relating to the robot-object system environment, and having a configuration data memory, wherein a computer program product as claimed in claim 12 for carrying out the method, which with the digital robot twin and the configuration data memory, forms a functional unit for configuring the robot-object system environment.

15. A robot having a robot controller as claimed in claim 14.
